(19) United States
(12) Patent Application Publication
(10) Pub. No.: US 2007/0175714 A1
(43) Pub. Date: Aug. 2, 2007

(54) Parking brake for a motor vehicle

(75) Inventors: Friedrich Saibold, Passau (DE); Stefan Reicheneder, Passau (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/648,927

(22) Filed: Jan. 3, 2007

(30) Foreign Application Priority Data
Jan. 14, 2006 (DE) 102006001893.1

(51) Int. Cl. F16D 65/24

(52) U.S. Cl. 188/170

(57) ABSTRACT

A parking brake for a motor vehicle comprises a disk packet (12) on an axle body in a brake housing (1) with at least one brake disk, one spring (8), by way of which the closure of the brake is effected by compression of the disk packet and a piston (7), superimposed on the spring. A compression space (6) of which piston can be subjected to hydraulic pressure for releasing the parking brake counter to the engaging force of the spring. The force of the piston is transferred by at least one pressure pin (4) onto a pressure transmission element (2). The element communicates with the disk packet and the pressure pin is located within the pressure space of the piston such that no connection exists between the pressure pin and an axle space (11) such that leakage of hydraulic fluid out of the compression space into the axle space is prevented.

This application claims priority from German Application Serial No. 10 2006 001 893.1 filed Jan. 14, 2006.

### FIELD OF THE INVENTION

The present invention concerns a parking brake for a motor vehicle.

### BACKGROUND OF THE INVENTION

According to the state of the technology, parking brakes for motor vehicles are known, which are engaged by spring action and are disengaged by way of hydraulic pressure. These brakes possess at least one brake disk placed upon an axle body and a spring for the compression of the at least one brake disk. Further, for releasing the brake disk against the force of the spring, a piston is provided, the pressure space of which can be subjected to hydraulic pressure. Such brakes are commonly installed on the axles of factory floor conveyance vehicles.

Further following the state of the technology, in the piston is at least one boring, which exhibits a pin therein, wherein the pin transfers the spring force to the brake disks by way of a plate which, in a sealing manner, is tightly proximal to the pressure space of the piston and which serves as the pressure transmission element. In this arrangement, the pin is retained by a cylindrical section in the boring of the piston. In this way, the piston of the service brake can be installed as the pressure transmission element, provided that the service brake and the parking brake use the same brake disks.

EP 1 181 178 B1 of the Applicant makes a gear train for a parking brake known, wherein a driving motor drives a first planetary stage which, by way of a second planetary gear stage, energizes a drive mechanism and by way of a respective service or parking brake, which is in series with the second planetary gear stage, can serve as a braking medium. In this way, the brake possesses an activation apparatus which, in the non-pressurized state of a first part of the activation apparatus, engages the brake as a parking brake. Conversely, upon the application of hydraulic pressure onto the first part of the activation apparatus, the brake disengages to serve as a parking brake. To continue, upon the application of pressure to a second part of the activation apparatus, the brake closes.

DE 102 01 366 A1 of the Applicant teaches of a spring force activated, hydraulic pressure released parking brake (also known as “SAHR” or Spring Applied Hydraulic Released parking brake) for motor vehicles. On an axle body in a brake housing, this brake encompasses brake disks, a spring—with which the brake disks can be compressed together—and a piston, which can counteract the spring, wherein the piston compression space can be subjected to hydraulic pressure to effect the release of the brake.

In this way, the piston possesses at least one boring, which is respectively provided with a pressure pin. The pin is retained in a cylindrical section in the piston boring, whereby in this cylindrical section, this pin possesses a radial groove. According to DE 102 01 366 A1, the boring in the piston is a blind boring with a radial groove. Further, an annular spring is provided, which can be mounted in the radial groove of the cylindrical section of the pin and the blind boring in the piston. The at least one pin is operationally-bound by way of a pressure transmission element to the disk packet. Normally, the piston of the service brake serves as a pressure transmission element.

The particulars of this known design indicate that in a case of a released brake, i.e., while in operational use, the pressure space of the piston remains under pressure, which condition could contribute to the leakage of hydraulic fluid into the space reserved for the axle.

The purpose of this invention is to make a parking brake for motor vehicles available, which parking brake is engaged by pressure and is disengaged by hydraulic pressure, wherein a leakage of the hydraulic fluid is prevented.

### SUMMARY OF THE INVENTION

Accordingly, a parking brake for a motor vehicle is proposed, which includes in its assembly at least one brake disk contained in disk packet on an axle body; these being enclosed in a brake housing and also a spring by way of which the disk packet can be compressed for the purpose of engaging the brake and countering the spring is also a piston; the pressure space of which can be subjected to hydraulic pressure in order to release the parking brake. In this assembly, the piston separately contacts the at least one pressure pin which, by way of a pressure transmission element, is in an operative connection with the disk packet. In this arrangement, there is to be found, axially successively in the following order: the disk packet, the pressure transmission element, pressure pin, piston and spring.

In this arrangement, the pressure pin is placed inside of the pressure space for the piston in such a manner that no connection exists between the pressure pin and the space for the axle. This placement will have the result that no leakage of the hydraulic fluid out of the piston space into the axle space can occur. According to the invention, a portion of the pressure transmission element radially extends itself to intervene between the axle space and the pressure pin.

According to this particularly advantageous embodiment of the present invention, the piston of the service brake operates as the pressure transmission element, which functions for the entry of the service brake into the disk packet.

### BRIEF DESCRIPTION OF THE DRAWING

The invention will now be described, by way of example, with reference to the accompanying drawing. A case is presented where one disk packet is mutually necessary for the service brake, as well as for the parking brake so that the piston of the service brake can operate as the pressure transmission element. There is shown in:

FIG. 1 is a schematic, sectional view of a parking brake in accordance with the state of the technology;

FIG. 2 is a schematic, sectional view of an advantageous embodiment of a parking brake in accordance with the present invention.

### DETAILED DESCRIPTION OF THE INVENTION

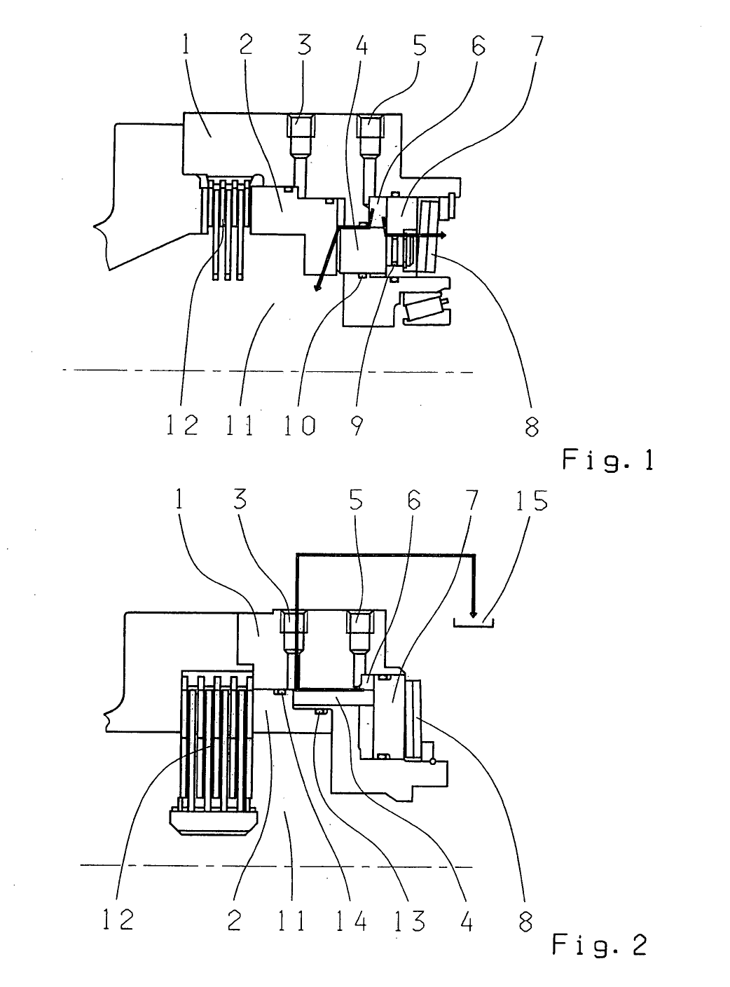

Taking note of FIG. 1, according to the state of technology, the parking brake includes a brake disk, i.e., a brake disk packet 12, as well as at least one pressure pin 4 which stands in an operative connection with the piston 2 of the service brake and the pin is contactingly related to a piston 7, the compression space 6 of which the piston 7 can be subjected to pressure for the release of the parking brake. The application of pressure would be effected through the line leading to and from a feed fitting 5. The reference number 3 designates the line and fitting for the filling of the pressure space of the piston 2 of the service brake. For the activation of the parking brake, a plate spring 8 is provided, whereby the spring force is conducted through the piston 7 of the parking brake, the pressure pin 4 and the service brake piston 2 and thus finally to the disk packet 12.

For the opening, i.e., the release of the parking brake, a compression space 6 is subjected to pressure from the line 5 so that the piston 7 compresses the plate spring 8, whereby the disk packet 12 is made free.

As has already been explained, the hydraulic fluid, held continually under pressure in a case of a released parking brake, can lead to leakage at sealings 10, 9, whereby the fluid can migrate in an eventually harmful manner into an axle space 11 and also simultaneously enter into the plate spring 8. This is made clear in FIG. 1 by the bold arrows.

In FIG. 2, the solution to the problem of such leakage is shown.

In this case, the pressure pin 4 is placed within the pressure space of the piston 7 in such a manner that no communication can exist between the pressure pin 4 and the axle space 11. According to the invention, a part of the piston 2 of the service brake has been radially placed between the axle space 11 and the pressure pin 4. This having been done, FIG. 2 shows that a shoulder has been created, which axially extends itself in such a way that between the axle space 11 and the pressure pin 4, no connection can exist.

As is further evident from FIG. 2, sealing means 13 and 14 are provided, between which that end, which is proximal to the disk packet 12 of the pressure pin 4, can move. Also, the sealing means 13 and 14 serve for the cut-off closure between the pressure space of the piston 2 of the service brake and the axle space 11.

By way of the inventive conception, it is possible that the leaked hydraulic fluid cannot migrate out of the pressure space 6 of the parking brake into the axle space 11, but rather escape into the pressure space of the piston of the service brake from which it can back-flow into a tank 15 through the inlet connection fitting 3 as is shown by an arrow in FIG. 2.

According to the invention in an advantageous manner, no sealing means are necessary between the pressure pin 4 and the brake housing 1. The reason for this is that between the pressure pin 4 and the brake housing 1 is present only a narrow fissure and leakage therefrom is insignificant. Leakage of hydraulic fluid collects in the pressure space of the piston 2 and can return to the supply tank 15 by way of the inlet fitting 3.

The arrangement presented here, for example, can be installed in equipment wherein, when the service brake is idle, a brake valve is open as is the brake line to the hydraulic tank as is the case for brake systems with auxiliary support.

A sealing means can be provided between the pressure pin 4 and the brake housing 1, if the invented parking brake has been installed with mechanically activated brake equipment without auxiliary support.

Further, it is possible that the parking brake can allow the back-flow of leaking hydraulic fluid into the tank 15, without the already described mutual use of the disk packet for the service brake and parking brake. In such a case, the connection fitting serves exclusively for the back-flow of the leaked hydraulic fluid into the tank.

Obviously, any advantageous improvement, especially regarding a spatial arrangement of the components of the invented parking brake as to each alone, as well as in combination with one another, which improvement is technically an advancement, falls under the protective framework of the present claims, without the function of the parking brake, as this is presented in the claims. This protection is to be given consideration, even when this improvement is not explicitly presented in the Figures or in the description.

### REFERENCE NUMERALS

1 brake housing
2 piston of the service brake, where service brake=pressure transmission element
3 connection fitting for the filling of the compression space of the piston
4 pressure pin
5 connection fitting for the filling of the compression space of the piston 7
6 compression space for the piston 7
7 piston (for the parking brake)
8 plate spring
9 sealing means
10 sealing means
11 axle space
12 brake disk packet
13 sealing means
14 sealing means
15 tank, supply and retrieval of hydraulic fluid

1-5. (canceled)

6. A parking brake for a motor vehicle, the parking brake comprising a disk packet, on an axle body in a brake housing (1), having at least one brake disk, one spring by which the disk packet being compressible to engage the brake, and a piston to counter the spring, a pressure space is subjected to pressure for releasing the parking brake against a force of the spring, the piston is connected to at least one pressure pin which is in operative communication with a pressure transmission element, the pressure pin (4) is placed within the pressure space (6) of the piston (7) in such a manner that no connection between the pressure pin (4) and the axle space (11) can exist, thus preventing leakage of hydraulic fluid out of the pressure space (6) into the axle space (11).

7. The parking brake for a motor vehicle according to claim 6, wherein a portion of the pressure transmission element (2) is radially located between the axle space (11) and the pressure pin (4).

8. The parking brake for a motor vehicle according to claim 6, wherein the pressure pin (4) is placed such that an end of the pressure pin (4), proximal to the disk packet (12), is movable between a first sealing means (13) and a second sealing means (14), whereby the second sealing means (14) seals the pressure transmission element (2) from the disk packet (12).

9. The parking brake for a motor vehicle according to claim 6, wherein a small separating fissure, between the brake housing (1) and the pressure pin (4), allows a small leakage of hydraulic fluid such that the leakage of hydraulic fluid from the pressure space (6) returns to a tank (15) by way of a connection fitting (2).

10. The parking brake for a motor vehicle according to claim 6, wherein a piston of a service brake is in the pressure transmission element (2).
